(19) United States
(12) Patent Application Publication
(10) Pub. No.: US 2011/0084948 A1
(43) Pub. Date: Apr. 14, 2011

(54) LCD DRIVER CIRCUIT AND DRIVING METHOD THEREOF

(76) Inventor: Kun-Tsung LIN, Tai Chung City (TW)

(21) Appl. No.: 12/902,609

(22) Filed: Oct. 12, 2010

(30) Foreign Application Priority Data
Oct. 9, 2009 (TW) 098134234

(51) Int. Cl. G09G 5/00

(52) U.S. Cl. 345/211

(57) ABSTRACT

An LCD driver circuit having a common electrode, a gate driving circuit and a source driving circuit is provided. The LCD driver circuit is applied to a display panel which has a plurality of pixels, a plurality of scan lines and a data line. The scan lines are divided into a plurality of scan line groups. The scan line groups are disposed on the display panel in a first sequence. The common electrode outputs a common voltage. The gate driving circuit is coupled to the scan lines and provides a control voltage to each scan line in a second sequence different from the first sequence. The source driving circuit is coupled to the data line to provide a gray level voltage to the data line. An area of the gray level voltage being higher or lower than the common voltage corresponds to a high level area of the control voltages in the nonadjacent scan line groups, and polarities of the operated pixels in the adjacent scan line groups are opposite.

### BACKGROUND OF THE INVENTION

(a) Field of the Invention

The invention relates to a LCD driver circuit and a driving method thereof, particularly to a LCD driver circuit and a driving method thereof having function of saving electricity.

(b) Description of the Related Art

FIG. 1 shows a block diagram of a conventional LCD driver circuit. The LCD driver circuit 100 is applied to a display panel 15 and comprises a timing controller 11, a gate driving circuit 12, a source driving circuit 13 and a common electrode 14. The display panel 15 has a plurality of pixels, a plurality of scan lines X1˜Xn and a plurality of data lines Y1˜Ym. The scan lines X1˜Xn are coupled to the gate driving circuit 12, the data lines Y1˜Ym are coupled to the source driving circuit 13 so as to operate the pixels. Each pixel is implemented by using a thin film transistor T1 and a storage capacitor C1. An end of the storage capacitor C1 is coupled to the source terminal of the thin film transistor T1, and another end of the storage capacitor C1 is coupled to the common electrode 14. The source terminal of the thin film transistor T1 is coupled to one of the data lines, the gate terminal of the thin film transistor T1 is coupled to one of the scan lines X1˜Xn. In operation of the liquid crystal display 10, the gate driving circuit 12 transmits control voltages VTs to the scan lines X1˜Xn, so that a plurality of thin film transistors T1 is turned on in order. The source driving circuit 13 transmits the gray level voltages VDs to the data lines Y1˜Ym. The storage capacitor C1 of each pixel can receive the gray level voltages VDs via the thin film transistor T1 so that its capacitance is charged to a target voltage to change the transmittance of the liquid crystal (not shown).

To prevent the liquid crystal being damaged, the alternating current may be used to drive the liquid crystal display 10, that is, the gray level voltages VDs of the data lines Y1˜Ym are higher or lower than the common voltage alternately. DC VCOM driving method and VCOM swing driving method are two kinds of general driving methods used in an LCD technology.

FIG. 2A shows an oscillogram of the common voltage and a gray level voltage of a data line according to DC VCOM driving method. FIG. 2B shows an oscillogram of the common voltage and a gray level voltage of a data line according to VCOM swing driving method. According to the DC VCOM driving method usually used in a big display panel, the common voltage VCOM is in a fixed level voltage. According to the VCOM swing driving method usually used in a small display panel, the common voltage VCOM is alternately switched between a high voltage and a low voltage to correspond the gray level voltage VD.

Generally, the liquid crystal display 10 shows sixty pictures in one second (60 Hz screen refresh rate), and each picture is called a frame. When a picture is displayed, in order to prevent crosstalk effect, the source driving circuit 13 treats a pixel or two pixels as a unit to drive the scan lines Y1˜Ym in a way that the gray level voltages are higher or lower than the common voltage. To make it easy to describe the present invention, hereafter a pixel in which the gray level voltage is higher than the common voltage is deemed to have a positive polarity, and a pixel in which the gray level voltage is lower than the common voltage is deemed to have a negative polarity. FIG. 3 shows the polarity of the gray level voltage of each pixel in a picture, that is, the polarity of each pixel operated by scan lines and data lines. As shown in FIG. 3, the gate driving circuit 12 respectively provides a control voltage VT to each scan line in a sequence of the scan lines X1˜X12 disposed on the display panel. The data line Y1 provides a gray level voltage VD having positive polarity for the pixels turn on by the scan lines X1 and X2, which serve as a scan line group G1. Then, the polarity of the gray level voltage VD provided for the data line Y1 is changed to be negative, that is, the data line Y1 provides the gray level voltage VD having negative polarity for the pixels turn on by the scan lines X3 and X4, which serve as a scan line group G2. The follow-up polarity change of the gray level voltage VD of the data line Y1 is shown in FIG. 3, and it detailed description will be omitted. FIG. 4 shows an oscillogram of the voltage applied to a data line Y1 and scan lines X1˜X12. As shown in FIG. 4, the high level area of the control voltages of the scan lines X1 and X2 is located in the positive polarity area of the gray level voltage of the data line Y1. The high level area of the control voltages of the scan lines X3 and X4 overlaps the negative polarity area of the gray level voltage of the data line Y1. As a result, pixels corresponding to the data line Y1 and the scan lines X1 and X2 have a positive polarity, and pixels corresponding to the data line Y1 and the scan lines X3 and X4 have a negative polarity.

The polarity of the gray level voltage applied to the data line Y1 is continually changed and then the pixels in the display panel are continually charged and discharged. This is large consumption of electricity. Hence one can see that, there are drawbacks needed to be improved in the conventional LCD (liquid crystal display) driver circuit.

### SUMMARY OF THE INVENTION

According to one embodiment of the invention, an LCD (liquid crystal display) driver circuit adapted for a display panel is provided. The display panel has a plurality of pixels, a plurality of scan lines and a data line. The scan lines are divided into a plurality of scan line groups which are disposed on the display panel in a first sequence. The LCD (liquid crystal display) driver circuit comprises a common electrode, a gate driving circuit and a source driving circuit. The common electrode outputs a common voltage. The gate driving circuit is coupled to the scan lines and provides a control voltage for each scan line in a second sequence different from the first sequence. The source driving circuit is coupled to the data line to provide a gray level voltage for the data line. The gray level voltage is alternately switched to be higher and lower than the common voltage. An area of the gray level voltage being higher or lower than the common voltage corresponds to a high level area of the control voltages in the nonadjacent scan line groups, and polarities of the operated pixels in the adjacent scan line groups are opposite.

According to one embodiment of the invention, an LCD driving method adapted for driving a display panel is provided. The display panel has a plurality of pixels, a plurality of scan lines and a data line. The scan lines include a plurality of scan line groups which are disposed on the display panel in a first sequence. The LCD driving method comprises following steps: outputting a common voltage; providing a control voltage for each scan line in a second sequence different from the first sequence; and providing a gray level voltage for the data line, wherein the gray level voltage is alternately switched to be higher and lower than the common voltage, wherein an area of the gray level voltage being higher or lower than the common voltage corresponds to a high level area of the control voltages in the nonadjacent scan line groups so that polarities of the operated pixels in the adjacent scan line groups are opposite.

In the LCD driver circuit and the LCD driving method according to an embodiment of the present invention, an area of the gray level voltage being higher or lower than the common voltage corresponds to a high level area of the control voltages in the nonadjacent scan line groups, so that the frequency of changing the polarity of the gray level voltage may be reduced and then consumption of electricity is decreased.

### BRIEF DESCRIPTION OF THE DRAWINGS

FIG. 1 shows a schematic diagram illustrating the structure of a packet according to the prior art.

FIG. 2A shows an oscillogram of the common voltage and a gray level voltage of a data line according to DC VCOM-driving method.

FIG. 2B shows an oscillogram of the common voltage and a gray level voltage of a data line according to VCOM swing driving method.

FIG. 3 shows the polarity of the gray level voltage of each pixel in a picture, that is, the polarity of each pixel operated by scan lines and data lines.

FIG. 4 shows an oscillogram of the voltage applied to a data line Y1 and scan lines X1˜X12.

FIG. 5 shows a schematic circuit diagram of a LCD driver circuit according to an embodiment of the present invention.

FIG. 6 shows an oscillogram of the voltage applied to the data line Y1 and the scan lines X1˜X12.

FIG. 7 shows an oscillogram of the voltage applied to a data line and the scan lines.

FIG. 8 shows a LCD driving method according to an embodiment of the present invention.

FIG. 9A shows an oscillogram of a data line and the common voltage according to an embodiment of the present invention.

FIG. 9B shows an oscillogram of a data line and the common voltage according to an embodiment of the present invention.

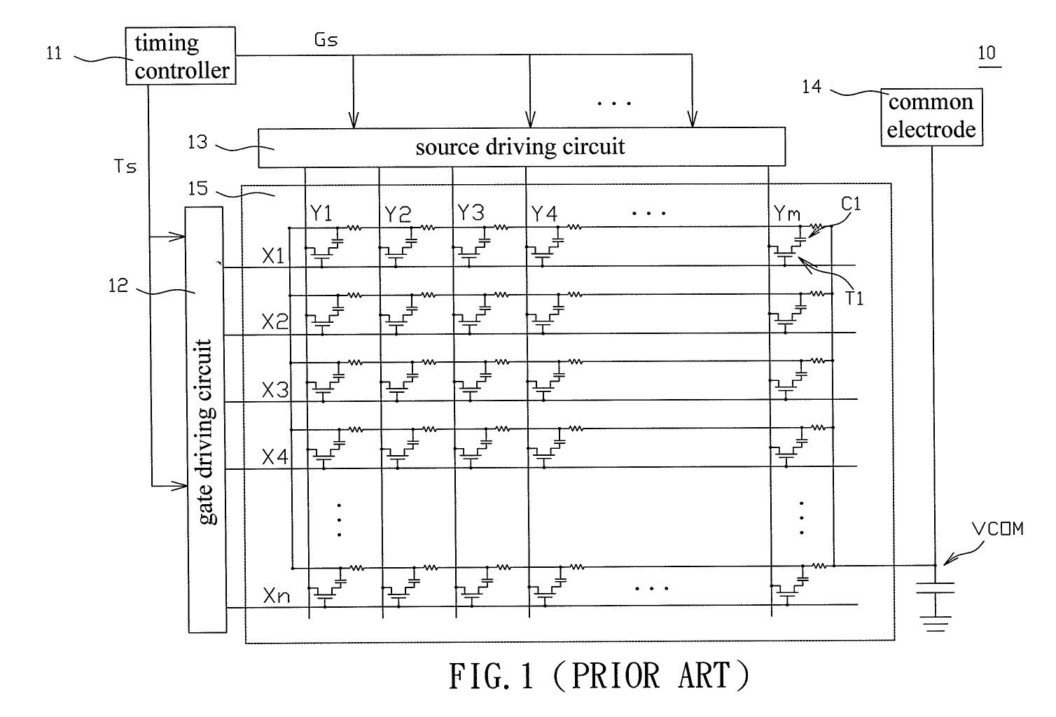

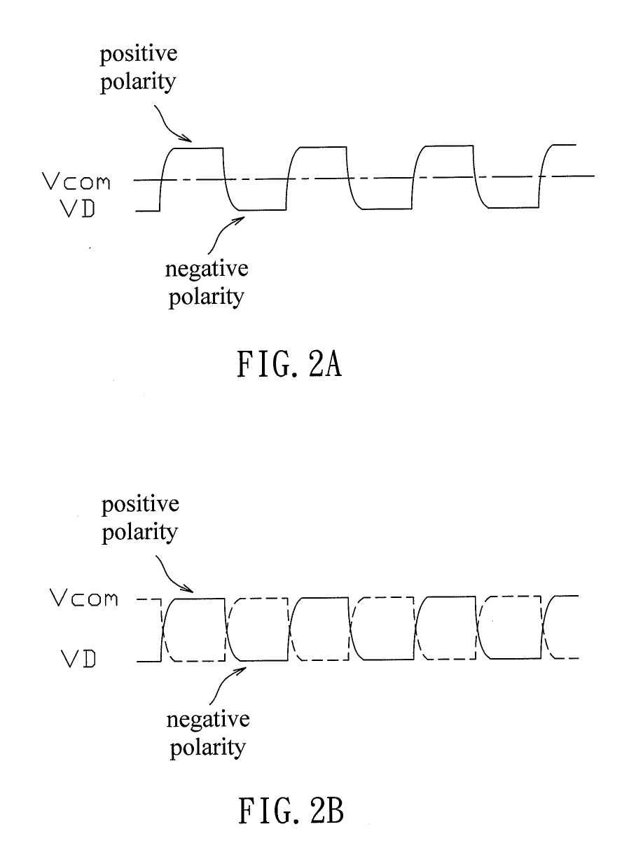

### DETAILED DESCRIPTION OF THE INVENTION

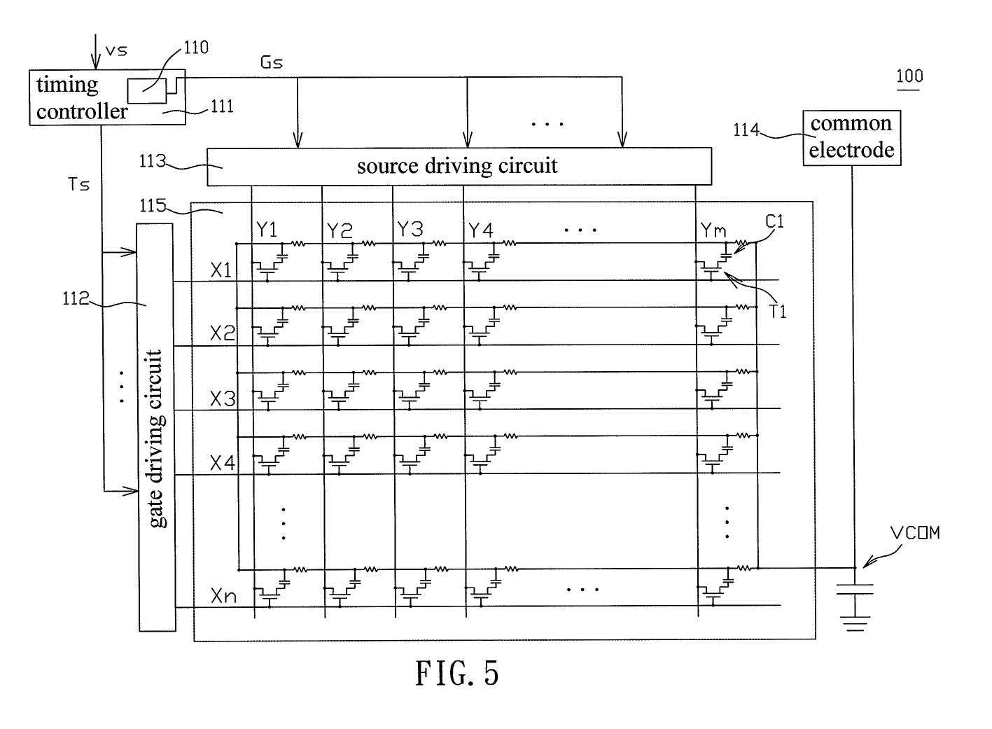

FIG. 5 shows a schematic circuit diagram of a LCD (liquid crystal display) driver circuit according to an embodiment of the present invention. As shown in FIG. 5, the LCD driver circuit 100 comprises a gate driving circuit 112, a source driving circuit 113 and a common electrode 114. It is adapted for a display panel 15. The display panel 15 has a plurality of pixels, a plurality of scan lines X1˜Xn and a plurality of data lines Y1˜Ym which are used to operate the pixels. The scan lines X1˜Xn are coupled to the gate driving circuit 112, the data lines Y1˜Ym are coupled to the source driving circuit 113. Each pixel is implemented by using a thin film transistor T1 and a storage capacitor C1. An end of the storage capacitor C1 is coupled to the source terminal of the thin film transistor T1, and another end of the storage-capacitor C1 is coupled to the common electrode 114. The source terminal of the thin film transistor T1 is coupled to one of the data lines, the gate terminal of the thin film transistor T1 is coupled to one of the scan lines X1˜Xn. The common electrode 114 outputs a common voltage VCOM. In this embodiment, the LCD driver circuit 100 further comprises a timing controller 111. The timing controller 111 has a memory unit 110 and is coupled to the gate driving circuit 112 and the source driving circuit 113.

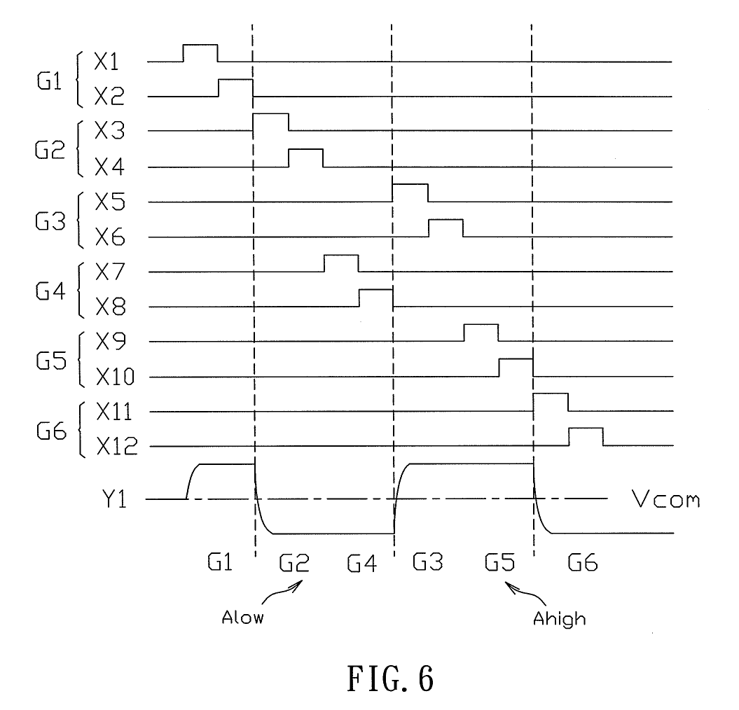

FIG. 6 shows an oscillogram of the voltage applied to the data line Y1 and the scan lines X1˜X12. To make it easy to describe the present invention, the data line Y1 and the scan lines X1˜X12 are used as an example hereafter. As shown in FIGS. 5 and 6, in this embodiment, the scan lines X1˜X12 are divided into a plurality of scan line groups G1˜G6 which are disposed on the display panel 115 in a sequence being from G1 to G6. The timing controller 111 is used for receiving a video signal vs and then generating a control voltage data signal Ts and a gray level voltage data signal Ds on the basis of the video signal vs. On the basis of the control voltage data signal Ts, the gate driving circuit 112 generates control voltages VTs to be outputted to the scan lines X1˜Xn. Each control voltage VT has a high level area. On the basis of the gray level voltage data signal Ds, the source driving circuit 113 generates gray level voltages VDs to be outputted to the data lines Y1˜Ym. The timing controller 111 determines a scan sequence. The timing controller 111 further outputs the control voltage data signal Ts on the basis of the scan sequence, and then outputs the gray level voltage data signal Ds corresponding to the output sequence of the control voltage data signal Ts. The gray level voltage data signal Ds may be stored in a memory unit 110. As shown in FIG. 6, the timing controller 111 outputs the control voltage data signal Ts in a second sequence being G1->G2->G4->G3->G5->G6 as opposed to the mentioned sequence being G1˜G6.

The gate driving circuit 112 coupled to the timing controller 111 and the scan lines X1˜X12 receives the control voltage data signal Ts in the second sequence being G1->G2->G4->G3->G5->G6. The gate driving circuit 112 further generates the control voltages VTs on the basis of the second sequence and provides the control voltages VTs to the scan lines X1˜X12 in the second sequence, G1->G2->G4->G3->G5->G6.

The source driving circuit 113 is coupled to the timing controller 111 and the data lines Y1′Ym. After receiving the gray level voltage data signal Ds, the source driving circuit 113 provides the gray level voltages VDs for the data lines Y1˜Ym on the basis of the gray level voltage data signal Ds, so that the pixels turned on by the control voltages VTs may obtain corresponding gray level voltages VDs. The gray level voltages VDs are alternately switched to be higher and lower than the common voltage. As shown in FIG. 6, the common voltage VCOM is at a fixed level voltage. The area Ahigh of the gray level voltage VD of the data line Y1 being higher than the common voltage VCOM corresponds to a high level area of the control voltages in the nonadjacent scan line groups (G3 and G5), or the area Alow of the gray level voltage VD of the data line Y1 being lower than the common voltage VCOM corresponds to a high level area of the control voltages in the nonadjacent scan line groups (G2 and G4). Accordingly, polarities of the operated pixels in the adjacent scan line groups are opposite.

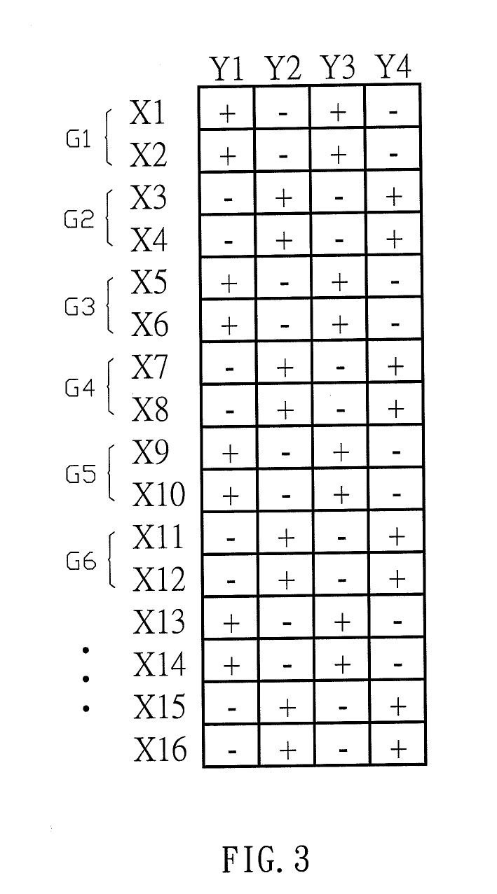

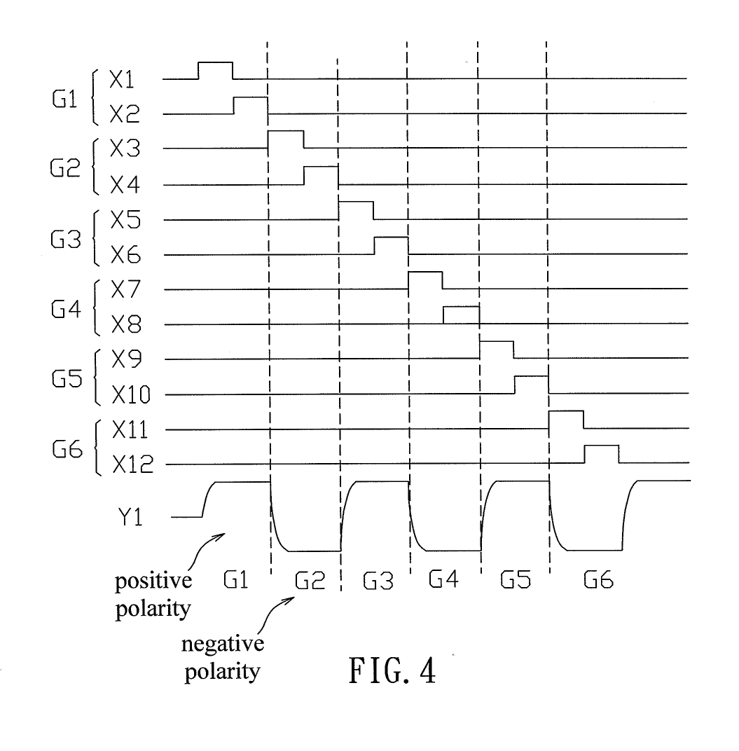

To prevent crosstalk effect, when a picture is shown, it is necessary that polarities of the operated pixels in the adjacent scan line groups are opposite. As shown in FIG. 3, the polarity of the pixels operated by the data line Y1, the scan lines X1˜X2 (scan line group G1), the scan lines X5˜X6 (scan line group G3), and the scan lines X9˜X10 (scan line group G5) is positive. The polarity of the pixels operated by the data line Y1, the scan lines X3˜X4 (scan line group G2), the scan lines X7˜X8 (scan line group G4), and the scan lines X11˜X12 (scan line group G6) is negative. As shown in FIG. 6, in this embodiment, since the gate driving circuit 112 provides the control voltages VTs for the scan line group G4, and then for the scan line group G3, the area Alow or Ahigh of the gray level voltage VD of the data line Y1 may be enlarged to a predetermined extent such that the area Alow or Ahigh may correspond to the high level areas of the control voltages VTs in the scan line groups G2 and G4 or in the scan line groups G3 and G5. Either the scan line groups G2 and G4 or the scan line groups G3 and G5 are nonadjacent and have the same polarities. As a result, the frequency of changing polarity of the gray level voltage may be reduced and then consumption of electricity is decreased.

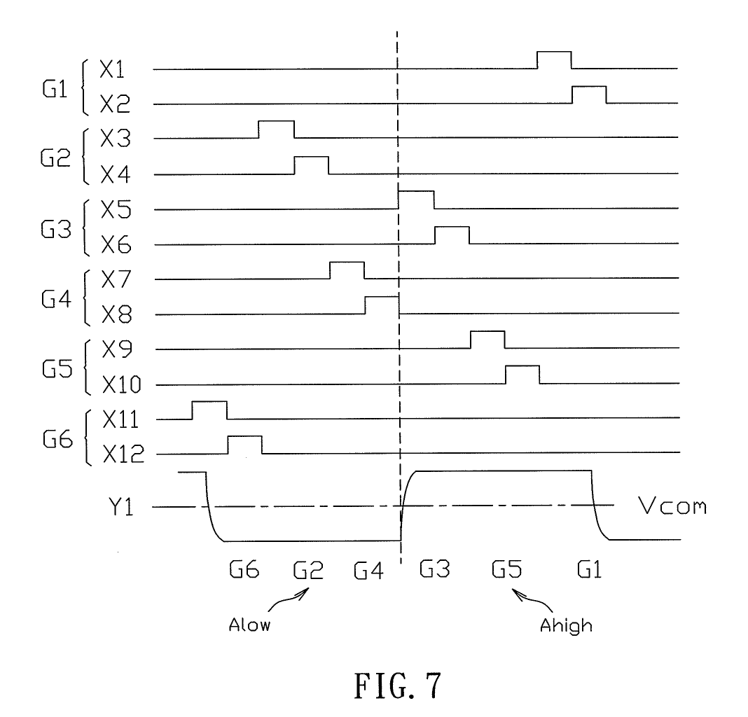

It is noted that this embodiment uses the scan sequence in which the orders of the scan line groups G3 and G4 are interexchanged as an example to describe, however the present invention is not limited thereto. FIG. 7 shows an oscillogram of the voltage applied to a data line and the scan lines. As shown in FIG. 7, the area Alow or Ahigh of the gray level voltage VD of the data line Y1 may be enlarged to a predetermined extent such that the area Alow or Ahigh may correspond to high level areas of the control voltages VTs in the scan line groups G6, G2 and G4 or in the scan line groups G3, G5 and G1. Either the scan line groups G6, G2 and G4 or the scan line groups G3, G5 and G1 are nonadjacent and have the same polarities. The embodiment in FIG. 7 can further reduce the frequency of changing polarity of the gray level voltage and then decrease consumption of electricity, since the area Alow or Ahigh are involved with three scan line groups according to the embodiment in FIG. 7 while they are involved only with two scan line groups according to the embodiment in FIG. 6. In the embodiment in FIG. 7, the gate driving circuit 112 provides the control voltages VTs for the scan lines X1˜X12 in a sequence being G6->G2->G4->G3->G5->G1. Specifically, the embodiment in FIG. 6 can save up to about half of electric energy used in the conventional technique while the embodiment in FIG. 7 can save up to about two thirds of electric energy used in the conventional technique.

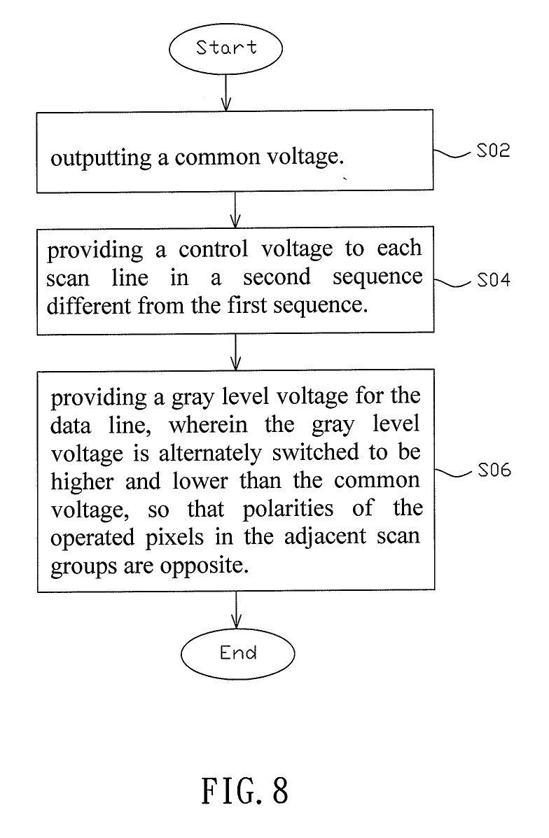

FIG. 8 shows a LCD driving method according to an embodiment of the present invention. The LCD driving method is adapted for driving a LCD panel which comprises a plurality of pixels, a plurality of scan lines, and a data line. The scan lines are divided into a plurality of scan line groups which is arranged on the display panel in a first sequence. The LCD driving method comprises following steps.

Step S02: outputting a common voltage.

Step S04: providing a control voltage for each scan line in a second sequence different from the first sequence.

Step S06: providing a gray level voltage for the data line, wherein the gray level voltage is alternately switched to be higher and lower than the common voltage, so that polarities of the operated pixels in the adjacent scan line groups are opposite.

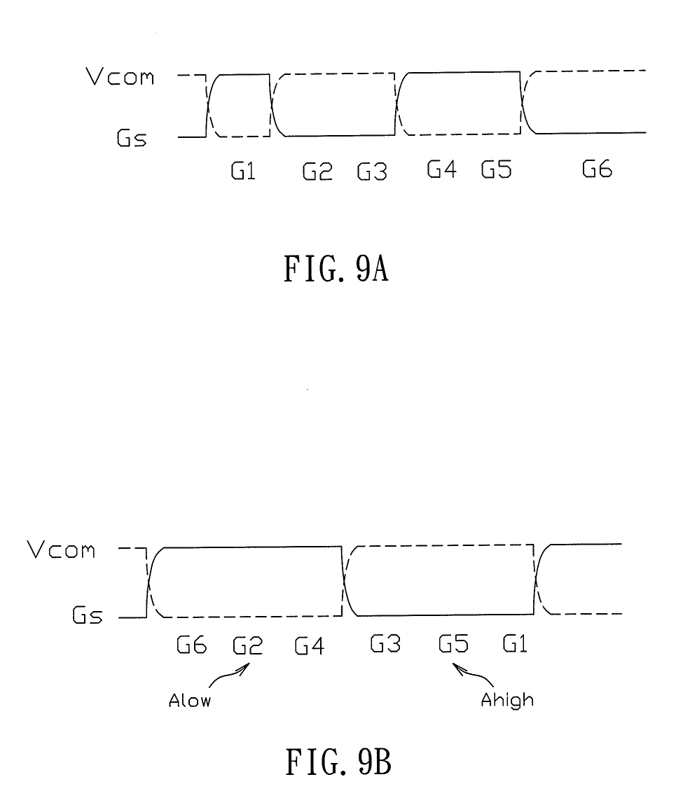

It is noted that the DC VCOM driving method, in which the common voltage VCOM is at a fixed level voltage, is only used as an example to describe an embodiment of the present invention. The present invention may also be applied to the VCOM swing driving method in which the common voltage VCOM is alternately switched between a high voltage and a low voltage. As shown in FIGS. 9A and 9B, the common voltage VCOM is alternately switched between a high voltage and a low voltage to correspond the gray level voltages VDs. The frequency of changing the polarity of the common voltage VCOM is the same as the frequency of changing the polarity of the gray level voltages. However, the polarity of the common voltage VCOM is opposite to that of the gray level voltages. Since both of the frequencies of changing the polarity of the common voltage VCOM and the gray level voltages are reduced, consumption of electricity may be further reduced in the display that is driven by the LCD driving method using the VCOM swing driving method according to an embodiment of the present.

According to an embodiment of the present, the gate driving circuit 112 does not provide a control voltage for each scan line in the sequence in which the scan line groups is disposed on display panel. By appropriate design, polarities of the operated pixels in the adjacent scan line groups may be opposite, and the area of the gray level voltage of data line being higher or lower than the common voltage corresponds to the high level areas of the control voltages in the nonadjacent scan line groups which have the same polarity. Compared with the conventional technique, the frequency of changing the polarity of the gray level voltage is reduced and then consumption of electricity is also decreased.

What is claimed is:

1. An LCD driver circuit adapted for a display panel having a plurality of pixels, a plurality of scan lines and a data line, the scan lines including a plurality of scan line groups which are disposed on the display panel in a first sequence, the LCD driver circuit comprising:
a common electrode outputting a common voltage;
a gate driving circuit coupled to the scan lines and providing a control voltage for each scan line in a second sequence different from the first sequence; and
a source driving circuit coupled to the data line to provide a gray level voltage to the data line, wherein the gray level voltage is alternately switched to be higher and lower than the common voltage,
wherein an area of the gray level voltage being higher or lower than the common voltage corresponds to a high level area of the control voltages in the nonadjacent scan line groups, and polarities of the operated pixels in the adjacent scan line groups are opposite.

2. The LCD driver circuit according to claim 1, further comprising a timing controller for receiving a video signal and storing a gray level voltage data signal of the video signal into a memory unit in the timing controller, wherein the source driving circuit uses the gray level voltage data signal to generate the gray level voltage.

3. The LCD driver circuit according to claim 1, wherein the common voltage is at a fixed level voltage.

4. The LCD driver circuit according to claim 3, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group in turn;
the second sequence is from the first scan line group, to the second scan line group, to the forth scan line group, to the three scan line group, to the fifth scan line group and then to the sixth scan line group in turn;
the second scan line group and the forth scan line group are nonadjacent and in the situation where the gray level voltage provided for the data line is lower than the common voltage; and
the third scan line group and the fifth scan line group are nonadjacent and in the situation where the gray level voltage provided for the data line is higher than the common voltage.

5. The LCD driver circuit according to claim 3, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group;
the second sequence is from the sixth scan line group, to the second scan line group, to the forth scan line group, to the three scan line group, to the fifth scan line group and then to the first scan line group;
the sixth scan line group ,the second scan line group and the forth scan line group are nonadjacent and in the situation where the gray level voltage provided for the data line is lower than the common voltage;
the three scan line group, the fifth scan line group and the first scan line group are nonadjacent and in the situation where the gray level voltage provided to the data line is higher than the common voltage.

6. The LCD driver circuit according to claim 1, wherein
the common voltage is alternately switched between a high voltage and a low voltage,
the frequency of changing the polarity of the common voltage is the same as the frequency of changing the polarity of the gray level voltage, and
the polarity of the common voltage is opposite to that of the gray level voltage.

7. The LCD driver circuit according to claim 6, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group in turn;
the second sequence is from the first scan line group, to the second scan line group, to the forth scan line group, to the three scan line group, to the fifth scan line group and then to the sixth scan line group;
the second scan line group and the forth scan line group are nonadjacent and in the situation where the gray level voltage provided for the data line is lower than the common voltage;
the third scan line group and the fifth scan line group are nonadjacent and in the situation where the gray level voltage provided for the data line is higher than the common voltage.

8. The LCD driver circuit according to claim 6, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group;
the second sequence is from the sixth scan line group, to the second scan line group, to the forth scan line group, to the three scan line group, to the fifth scan line group and then to the first scan line group;
the sixth scan line group ,the second scan line group and the forth scan line group are nonadjacent and in the situation where the gray level voltage provided for the data line is lower than the common voltage;
the three scan line group, the fifth scan line group and the first scan line group are nonadjacent and in the situation where the gray level voltage provided for the data line is higher than the common voltage.

9. An LCD driving method adapted for driving a display panel having a plurality of pixels, a plurality of scan lines and a data line, the scan lines including a plurality of scan line groups which are disposed on the display panel in a first sequence, the driving method comprising:
outputting a common voltage;
providing a control voltage to each scan line in a second sequence different from the first sequence; and
providing a gray level voltage to the data line, wherein the gray level voltage is alternately switched to be higher and lower than the common voltage,
wherein an area of the gray level voltage being higher or lower than the common voltage corresponds to a high level area of the control voltages in the nonadjacent scan line groups so that polarities of the operated pixels in the adjacent scan line groups are opposite.

10. The LCD driving method according to claim 9 further comprises:
receiving a video signal and storing a gray level voltage data signal of the video signal into a memory unit, wherein a source driving circuit uses the gray level voltage data signal to generate the gray level voltage.

11. The LCD driving method according to claim 9, wherein the common voltage is at a fixed level voltage.

12. The LCD driving method according to claim 11, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group in turn;
the second sequence is from the first scan line group, to the second scan line group, to the forth scan line group, to the three scan line group, to the fifth scan line group and then to the sixth scan line group in turn;
the second scan line group and the forth scan line group are nonadjacent and in the situation where the gray level voltage provided for the data line is lower than the common voltage;
the third scan line group and the fifth scan line group are nonadjacent and in the situation where the gray level voltage provided for the data line is higher than the common voltage.

13. The LCD driving method according to claim 11, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group;
the second sequence is from the sixth scan line group, to the second scan line group, to the forth scan line group, to the three scan line group, to the fifth scan line group and then to the first scan line group;
the sixth scan line group ,the second scan line group and the forth scan line group are nonadjacent and in the situation where the gray level voltage provided for the data line is lower than the common voltage;
the three scan line group, the fifth scan line group and the first scan line group are nonadjacent and in the situation where the gray level voltage provided for the data line is higher than the common voltage.

14. The LCD driving method according to claim 9, wherein
the common voltage is alternately switched between a high voltage and a low voltage,
the frequency of changing the polarity of the common voltage is the same as the frequency of changing the polarity of the gray level voltage, and
the polarity of the common voltage is opposite to that of the gray level voltage.

15. The LCD driving method according to claim 14, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group in turn;
the second sequence is from the first scan line group, to the second scan line group, to the forth scan line group, to the three scan line group, to the fifth scan line group and then to the sixth scan line group;
the second scan line group and the forth scan line group are nonadjacent and in the situation where the gray level voltage provided for the data line is lower than the common voltage;
the third scan line group and the fifth scan line group are nonadjacent and in the situation where the gray level voltage provided for the data line is higher than the common voltage.

16. The LCD driving method according to claim 14, wherein
the scan line groups comprises a first scan line group, a second scan line group, a three scan line group, a forth scan line group, a fifth scan line group and a sixth scan line group;
the first sequence is from the first scan line group, to the second scan line group, to the three scan line group, to the forth scan line group, to the fifth scan line group and then to the sixth scan line group;
the second sequence is from the sixth scan line group, to the second scan line group, to the forth scan line group, to the three scan line group, to the fifth scan line group and then to the first scan line group;
the sixth scan line group ,the second scan line group and the forth scan line group are nonadjacent and in the situation where the gray level voltage provided for the data line is lower than the common voltage;
the three scan line group, the fifth scan line group and the first scan line group are nonadjacent and in the situation where the gray level voltage provided for the data line is higher than the common voltage.
